(19) United States
(12) Patent Application Publication
(10) Pub. No.: US 2025/0261804 A1
(43) Pub. Date: Aug. 21, 2025

(54) STIRRING DEVICES AND BEVERAGE MAKING DEVICES

(71) Applicant: Dongguan ZEEWAY-Technology Ltd, Guangdong Province (CN)

(72) Inventors: Mengyi Zhu, Guangdong Province (CN); Liang Zhou, Guangdong Province (CN); Qiaohuang Li, Guangdong Province (CN); Riling Huang, Guangdong Province (CN); Long Chen, Guangdong Province (CN); Wenchao Deng, Guangdong Province (CN); Qihong She, Guangdong Province (CN); Fulin Lv, Guangdong Province (CN)

(73) Assignee: Dongguan ZEEWAY-Technology Ltd, Guangdong Province (CN)

(21) Appl. No.: 18/955,951

(22) Filed: Nov. 21, 2024

(30) Foreign Application Priority Data
Feb. 20, 2024 (CN) 2024203154528

(51) Int. Cl. A47J 43/08; A47J 43/046

(52) U.S. Cl. CPC A47J 43/085; A47J 43/046

(57) ABSTRACT

A stirring device comprises a stirring cup, including a stirrer provided therein, the stirrer being fixed to the bottom of the stirring cup, and the stirrer rotary shaft extending through the bottom of the stirring cup; and a motor, provided below the stirring cup, including an output shaft, via which the stirrer rotary shaft is driven. Wherein an axis of the motor output shaft is provided offset from an axis of the stirrer rotary shaft, and the motor output shaft is operatively connected to the stirrer rotary shaft via a torque transfer device. The present disclosure sets the axis of the motor output shaft of the mixing device offset from the axis of the rotating shaft of the agitator, which reduces the possibility of damage to the motor by liquid leakage under the premise of ensuring the stirring function of the stirring device. The present disclosure also provides a beverage making device incorporating the above stirring device, which realizes in-line stirring and prevents damage to the motor of the stirring device by leakage of liquid, and extends the service life of the device.

### TECHNICAL Field

This disclosure relates generally to the field of making beverages and, more specifically to stirring devices and beverage making devices incorporating such stirring devices.

### BACKGROUND

Existing beverage making devices usually require a variety of ingredients to be stirred to make a beverage in the process of making the beverage. However, the stirring device often suffers from leakage.

Although a sealing member is usually utilized for sealing to solve the liquid leakage problem, the sealing member may fail over time, and if it cannot be replaced in time, there is still a possibility of leakage and damaging a power source of the stirring device.

### SUMMARY

The stirring device and the beverage making device incorporating such stirring device of the present disclosure can solve or at least partially alleviate the above problem.

In one example, the stirring device comprises a stirring cup including a stirrer provided therein, the stirrer fixed to the bottom of the stirring cup, the stirrer rotary shaft extending through the bottom of the stirring cup; and a motor provided below the stirring cup, including an output shaft, via which the stirrer rotary shaft is driven. Wherein an axis of the motor output shaft is provided offset from the axis of the stirrer rotary shaft and the motor output shaft is operatively connected to the stirrer rotary shaft by a torque transfer device

In the technical solution provided by the present disclosure, the axis of the motor output shaft of the stirring device is provided offset from the axis of the stirrer rotary shaft, and the torque is transferred from the motor output shaft to the stirrer rotary shaft via the torque transfer device to realize stirring function. As a result, the stirring function of the stirring device is ensured so that, in the event that there is leakage of liquid along the stirrer rotary shaft, it does not flow directly to the motor output shaft, i.e., it does not flow into the motor, and thus the possibility of damage to the motor by leakage of liquid is reduced.

Preferably, the torque transfer device is a gearing device comprising gears meshing with each other and connected to the motor output shaft and the stirrer rotary shaft, respectively. The power is transmitted from the motor output shaft to the stirrer rotary shaft by the gearing device. Such configuration has a simple structure, high transmission efficiency, and good stability.

Preferably, a sealing member is provided between a portion of the motor output shaft extending out of the motor body and the motor body, further increasing the scaling to protect the motor from damage by leakage.

Preferably, a scaling member is provided between the stirrer rotary shaft and the torque transfer device, and further preventing liquid leakage.

The present disclosure also provides a beverage making device incorporating the stirring device as described above.

Preferably, an operating table is included. When the stirring cup is placed in position on the operating table, the stirrer rotary shaft extends through a shaft hole in the operating table and is operatively connected to an intermediate shaft provided below the operating table. The intermediate shaft is operatively connected to the motor output shaft through the torque transfer device.

Preferably, a mounting table is also included. The motor is mounted below the mounting table, and the torque transfer device is provided between the operating table and the mounting table. The motor is further isolated by the provision of the mounting table to protect the motor from damage by fluid leakage.

Preferably, the motor output shaft extends through the mounting table and a seal is provided therebetween to further protect the motor.

Preferably, a drain slot is provided in the mounting table around the motor output shaft to drain the leakage fluid from the mounting table. In the event that there is leakage liquid dripping onto the mounting table, the drain slot can drain the leakage liquid away, reducing the risk of the leakage liquid entering the motor.

Preferably, when the stirring cup is placed in position on the operating table, the mouth of the stirring cup corresponds to the dispensing port of the beverage making device to realize in-line stirring.

By combining the stirring device with the stirrer rotary shaft provided offset from the motor output shaft to the beverage making device, so that if there is a leakage of liquid from the mounting table it will not directly contact the motor output shaft, and thus the risk of the leakage of liquid directly into the motor is also reduced. Further, the motor is provided with multiple protections against damage from leakage through the provision of seals and a drain slot. This increases the service life of the motor and reduces production costs.

### BRIEF DESCRIPTION OF FIGURES

Other features, objects and advantages of the present disclosure will become more apparent by reading the detailed description of the non-limiting embodiments with reference to the following accompanying drawings:

FIG. 1 is a partial three-dimensional schematic illustration of a beverage making device incorporating a stirring device;

FIG. 2 shows a side view of FIG. 1; and

FIG. 3 shows a cross-sectional view taken along the line A-A in FIG. 2.

### DETAILED DESCRIPTION

The present disclosure is further described in detail below in connection with the accompanying drawings and embodiments. It is to be anticipate that the specific embodiments described herein are only for the purpose of explaining the present disclosure and are not a limitation. It is also to be noted that, for case of description, only the portions relevant to the present disclosure are shown in the accompanying drawings.

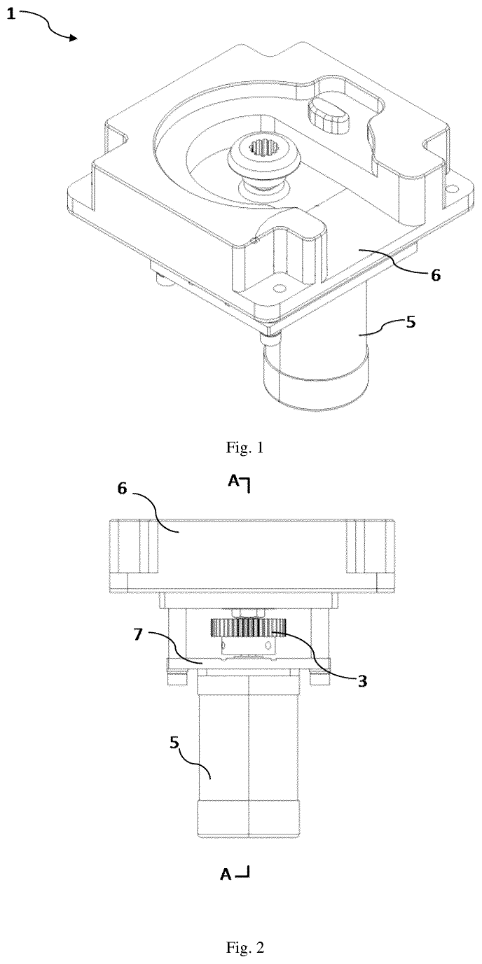

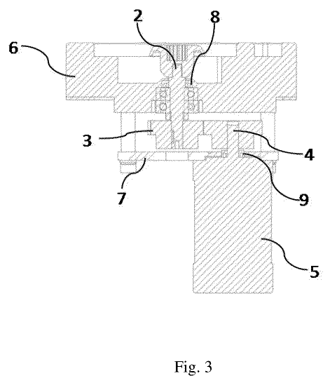

FIG. 1 is a partial three-dimensional schematic illustration of a beverage making device incorporating a stirring device; FIG. 2 is a side view of FIG. 1; and FIG. 3 is a cross-sectional view taken along a line A-A in FIG. 2. Reference number 1 is used to indicate the stirring device; reference number 2 is used to indicate the intermediate shaft; reference number 3 is used to indicate the torque transfer device; reference number 4 is used to indicate the motor output shaft; reference number 5 is used to indicate the motor; reference number 6 is used to indicate the operation table; reference number 7 is used to indicate the mounting table; reference number 8 is used to indicate the sealing member at the stirrer rotary shaft; and reference number 9 is used to indicate the sealing member positioned between the motor output shaft and the mounting table.

The stirring device of the present disclosure comprises: a stirring cup having a stirrer provided therein, the stirrer being fixed to the bottom of the stirring cup, and the stirrer rotary shaft extending through the bottom of the stirring cup; a motor provided below the stirring cup, the motor comprising an output shaft by which the stirrer rotary shaft is driven; wherein the axis of the motor output shaft is provided in offset with the axis of the stirrer rotary shaft, and the motor output shaft is operatively connected to the stirrer rotary shaft by a torque transfer device. When the motor is activated, its output shaft transfers torque to the stirrer rotary shaft via the torque transfer device, such that the stirrer stirs the substance in the stirring cup.

By setting the axis of the stirrer rotary shaft offset from the axis of the output shaft of its power source (the motor), liquid leaking from the stirrer rotary shaft, if present, does not flow directly onto the motor output shaft, and thus does not flow down the motor output shaft into the motor and cause damage to the motor.

In a preferred embodiment, the torque transfer device may be a gearing device comprising gears meshing with each other and connected to the motor output shaft and the stirrer rotary shaft, respectively. The power is transferred from the motor output shaft to the stirrer rotary shaft by the gearing device, and the stirrer rotary shaft is spaced from the motor output shaft by a distance of at least one inner diameter of the gears. Such a configuration has a simple structure, high transmission efficiency, and good stability of power transmission.

In the preferred embodiment, a sealing member may be provided between a portion of the motor output shaft that extends out of the motor body and the motor body, thereby further preventing liquid leaking from the stirrer rotary shaft from entering the motor and causing damage to the motor.

In the preferred embodiment, a sealing member may be provided between the stirrer rotary shaft and the torque transfer device to prevent the liquid from leaking down.

The present disclosure is further described below in conjunction with the accompanying drawings.

FIG. 1 is a schematic illustration of a portion of a beverage making device incorporating a stirring device, in which the stirring cup is not shown for the purpose of clarity. The stirring device 1 combined to the beverage making device enables in-line stirring, i.e. stirring while the beverage is being prepared. In the beverage making device of the present disclosure, an operating table 6 is provided on which the stirring device I can be mounted. When the stirring cup is placed in position on the operating table 6, a stirrer rotary shaft in the stirring cup extends through a shaft hole in the operating table 6 and is operatively connected to a coaxially disposed intermediate shaft 2 disposed below the operating table 6. The intermediate shaft 2 below the operating table 6 is indirectly connected to the motor output shaft 4 by means of the torque transfer device 3. When the motor 5 is turned on, the motor output shaft 4 rotates and transmits torque to the intermediate shaft 2 via the torque transfer device 3, and thus to the stirrer rotary shaft operatively connected to the intermediate shaft, so as to bring the stirring device into operation. By the above-described setting, while ensuring the stirring function of the stirrer, the motor 5 can be effectively prevented from being damaged by leakage of liquid by setting the axis of the motor output shaft offset from the axis of the stirrer rotary shaft.

Further reference is made to FIG. 2 and FIG. 3, FIG. 2 is a side view of FIG. 1 and FIG. 3 is a cross-sectional view taken along the line A-A of FIG. 2. It can be clearly seen in the figures that when the stirring cup is placed in position on the operating table 6, the stirrer rotary shaft extends through the shaft hole in the operating table 6 to be operatively connected to the intermediate shaft 2 which is provided coaxially with the stirrer rotary shaft, i.e. the intermediate shaft 2 can transfer torque to the stirrer rotary shaft to synchronize its rotation. The intermediate shaft 2, i.e. the stirrer rotary shaft, and the motor output shaft 4 are spaced apart from each other, parallel to each other, i.e. they are set off-set by a distance. The torque transfer device 3, which is preferably a gearing device, may be provided between the intermediate shaft 2 and the motor output shaft 4. The gearing device comprises gears that mesh with each other and are connected to the motor output shaft 4 and the intermediate shaft 2, respectively. As a result, power can be transferred from the motor output shaft to the stirrer rotary shaft by means of the gearing device.

In the preferred embodiment, a mounting table 7 is also provided below the operating table 6. In particular, as shown in FIG. 3, the torque transfer device 3 is provided between the operating table 6 and the mounting table 7, the motor 5 is mounted below the mounting table 7, and the motor output shaft 4 rotatably extends through the mounting table 7. The provision of the mounting table 7 further blocks the inflow of leakage fluid and damage to the motor, and allows for the intermediate shaft 2 and the torque transfer device, motor output shaft 4 and the motor 5 to provide support at the same time.

In the preferred embodiment, a sealing member (not shown) may be provided between a portion of the motor shaft output shaft 4 that extends out of the motor body and the motor body. Furthermore, the sealing member 9 may be provided between the motor output shaft 4 and the mounting table 7 for further protection of the motor 5 from damage by liquid leakage.

In the preferred embodiment, the sealing member 8 may be provided between the stirrer rotary shaft and the torque transfer device 3. Additionally, the operating table 6 is provided with a shaft hole for the stirrer rotary shaft to pass through, and the sealing member is provided at the shaft hole by conventional means. The sealing member 8 between the stirrer rotary shaft and the torque transfer device 3 in the present disclosure can be provided to prevent the liquid for cleaning the operation table 6 from leaking to below the operation table.

In the preferred embodiment, a drain slot (not shown) can be provided in the mounting table 7 around the motor output shaft 4 to drain the leakage fluid from the mounting table 7. In the event that there is leakage liquid dripping onto the mounting table 7, the drain slot can drain the leakage liquid away, reducing the risk of the leakage liquid entering the motor 5.

In the preferred embodiment, when the stirring cup (not shown) is placed in position on the operation table 6, the mouth of the cup corresponds to the dispensing port (not shown) of the beverage making device, in order to realize in-line stirring at the same time as or after the dispensing.

The technical solution proposed in the present disclosure effectively protects the power source of the stirring device from liquid leakage. Moreover, the whole device is simple in structure and has enhanced protective function, which prolongs the service life of the device.

The above description is only a preferred embodiment of the present disclosure and an illustration of the technical principles utilized. It should be understood by those skilled in the art that the scope of the present disclosure is not limited to the technical solution formed by a specific combination of the above technical features, but also covers other technical solutions formed by any combination of the above technical features or their equivalent features, without departing from the concept of the present disclosure mentioned above. For example, a technical solution formed by interchanging the above features with (but not limited to) technical features having similar functions disclosed in the present disclosure.

1. A stirring device, comprising:
a stirring cup, including a stirrer provided therein, the stirrer being fixed to the bottom of the stirring cup, and the stirrer rotary shaft extending through the bottom of the stirring cup;
a motor, provided below the stirring cup, including an output shaft, via which the stirrer rotary shaft is driven;
wherein an axis of the motor output shaft is provided offset from an axis of the stirrer rotary shaft, and the motor output shaft is operatively connected to the stirrer rotary shaft via a torque transfer device.

2. The stirring device of claim 1, wherein the torque transfer device is a gearing device comprising gears meshing with each other and connected to the motor output shaft and the stirrer rotary shaft, respectively.

3. The stirring device of claim 1, wherein a sealing member is provided between a portion of the motor shaft output shaft extending out the motor body and the motor body.

4. The stirring device of claim 1, wherein a sealing member is provided between the stirrer rotary shaft and the torque transfer device.

5. A beverage making device, comprising the stirring device according to claim 1.

6. The beverage making device of claim 5, wherein it comprises an operating table, when the stirring cup being placed in position on the operating table, the stirrer rotary shaft extending through a shaft hole in the operating table and being operatively connected to an intermediate shaft disposed below the operating table, and the intermediate shaft being operatively connected to the output shaft of the motor via the torque transfer device.

7. The beverage making device of claim 6, further comprising a mounting table provided below the operating table, the motor being mounted below the mounting table, and the torque transfer device being provided between the operating table and the mounting table.

8. The beverage making device of claim 7, wherein the output shaft of the motor extends through the mounting table and a sealing member is provided therebetween.

9. The beverage making device of claim 8, wherein a drain slot is provided on the mounting table around the motor output shaft to drain the leakage from the mounting table.

10. The beverage making device of claim 5, wherein the mouth of the stirring cup corresponds to the dispending outlet of the beverage making device when the stirring cup is placed in position on the operating table.
